(19) United States
(12) Patent Application Publication
(10) Pub. No.: US 2013/0010359 A1
(43) Pub. Date: Jan. 10, 2013

(54) POLARIZATION SYSTEM AND THREE DIMENSIONAL IMAGE DISPLAY APPARATUS HAVING THE SAME

(75) Inventors: Hee Wook DO, Cheonan-si (KR); Seungbeom Park, Seoul (KR); Duckjong Suh, Seoul (KR); Sang-Gu Lee, Seoul (KR); Yongkyu Jang, Hwaseong-si (KR); Min Oh Choi, Asan-si (KR)

(73) Assignee: Samsung Electronics Co., Ltd., Suwon-si (KR)

(21) Appl. No.: 13/431,496

(22) Filed: Mar. 27, 2012

(30) Foreign Application Priority Data
Jul. 8, 2011 (KR) 10-2011-0067989

(51) Int. Cl. G02B 27/26; G02B 27/28

(52) U.S. Cl. 359/465; 359/492.01

(57) ABSTRACT

A polarization system including a first polarization film, a second polarization film, and a first retardation film disposed between the first and second polarization films. The first polarization film is disposed between a user and a light irradiator and the second polarization film is disposed between the first polarization film and the light irradiator. In addition, the first retardation film retards a phase of the light passing through the first polarization film. Thus, the polarization system allows the user to watch a 3D image without being related to the user's posture. A second retardation film may also be disposed between the first polarization film and the first retardation film.

### CROSS-REFERENCE TO RELATED APPLICATION

This application claims priority from and the benefit of Korean Patent Application No. 10-2011-0067989 filed on Jul. 8, 2011, which is hereby incorporated by reference for all purposes as if fully set forth herein.

### BACKGROUND

1. Field

Exemplary embodiments of the present invention relate to a polarization system and a 3D image display apparatus having the same. More particularly, the present invention relates to a polarization system and a 3D image display apparatus having the polarization system, which is capable of allowing a viewer to watch a 3D image without being related to the posture of the viewer.

2. Description of the Background

Recently, a 3D image display apparatus provides a left-eye image and a right-eye image, which have a binocular disparity, to a left eye and a right eye of an observer, respectively. The observer watches the left and right images through the two eyes, thereby perceiving a 3D image.

The 3D image display apparatus provides a maximum brightness when a transmission axis of a polarization film attached to a surface of a display panel, from which the light exits, is parallel to a transmission axis of a polarization film attached to glasses worn by the observer, but the brightness becomes zero when the transmission axes are oriented at 90 degrees to one another. That is, the brightness of the 3D image display apparatus depends on the observer's posture.

### SUMMARY OF THE INVENTION

Exemplary embodiments of the present invention provide a polarization system capable of allowing a viewer to watch a 3D image without being related to the posture of the viewer.

Exemplary embodiments of the present invention also provide a 3D image display apparatus having the polarization system.

Additional features of the invention will be set forth in the description which follows, and in part will be apparent from the description, or may be learned by practice of the invention.

An exemplary embodiment of the present invention discloses a polarization system comprising a first polarization film, a second polarization film, and a first retardation film disposed between the first and second polarization films. The first polarization film is disposed between a viewer and a light irradiator and the second polarization film is disposed between the first polarization film and the light irradiator. The first retardation film retards a phase of a light exiting from one of the first and second polarization films.

An exemplary embodiment of the present invention also discloses a 3D image display apparatus comprising a display panel displaying a left-eye image and a right-eye image separately and a polarization system. The polarization system is disposed adjacent to a surface of the display panel, on which the left and right images are displayed, to allow a viewer to perceive a 3D image.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view showing a 3D image display apparatus according to a first exemplary embodiment of the present invention.

FIG. 2 is a cross-sectional view showing the 3D image display apparatus shown in FIG. 1.

FIG. 3 is a schematic view explaining a polarization system employed in the 3D image display apparatus shown in FIG. 1.

FIG. 4 is a cross-sectional view showing a 3D image display apparatus according to a second exemplary embodiment of the present invention.

FIG. 5 is a schematic view explaining a polarization system employed in the 3D image display apparatus shown in FIG. 4.

FIG. 6 is a graph showing a transmittance of a polarization system according to a face angle of a user.

FIG. 7 is a cross-sectional view showing a 3D image display apparatus according to a third exemplary embodiment of the present invention.

FIG. 8 is a schematic view explaining a polarization system employed in the 3D image display apparatus shown in FIG. 7.

FIG. 9 is a graph showing a brightness variation according to a thickness of a third retardation film and an angle of polarization glasses of the 3D image display apparatus shown in FIGS. 7 and 8.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will convey the scope of the invention to those skilled in the art. In the drawings, the size and relative sizes of layers and regions may be exaggerated for clarity. Like reference numerals in the drawings denote like elements.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

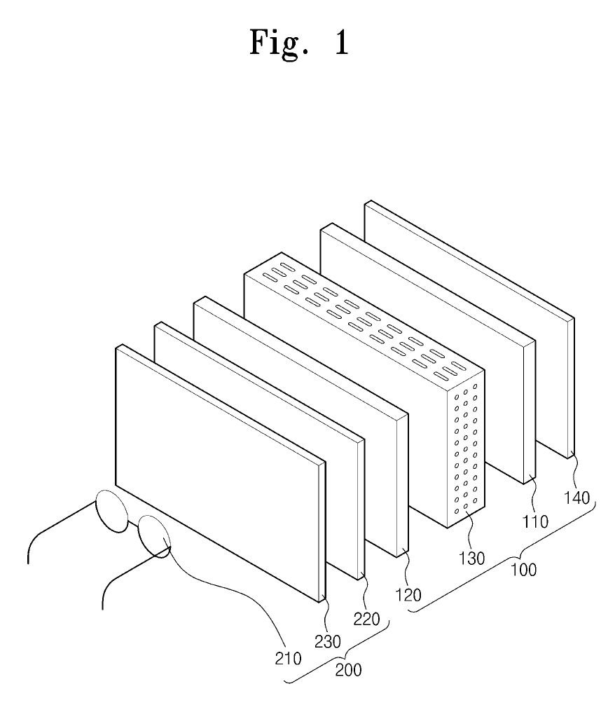

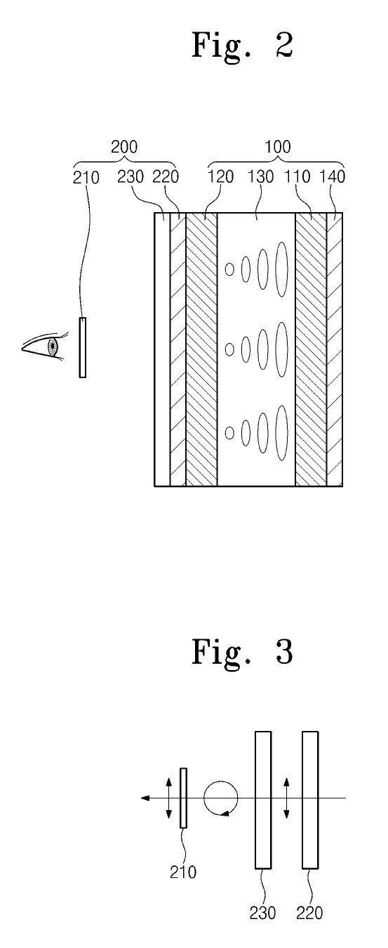

FIG. 1 is a perspective view showing a 3D image display apparatus according to an exemplary embodiment of the present invention, FIG. 2 is a cross-sectional view showing the 3D image display apparatus shown in FIG. 1, and FIG. 3 is a schematic view explaining a polarization system employed in the 3D image display apparatus shown in FIG. 1.

Referring to FIGS. 1 and 2, a 3D image display apparatus includes a display panel 100 and a polarization system 200.

The display panel 100 alternately displays a left-eye image and a right-eye image. In the present exemplary embodiment, various display panels, such as a liquid crystal display panel, an electrophoretic display panel, an organic light emitting display panel, a plasma display panel, etc., may be used as the display panel 100. The liquid crystal display panel will be described as the display panel 100 in the present exemplary embodiment.

The display panel 100 has a rectangular plate shape having a long side and a short side to display an image on a predetermined display area. In addition, the display panel 100 includes an array substrate 110, an opposite substrate 120 facing the array substrate 110, and a liquid crystal layer 130 disposed between the array substrate 110 and the opposite substrate 120.

According to the present exemplary embodiment, the array substrate 110 may include a plurality of pixels (not shown) arranged in a matrix form. Each pixel may include a plurality of sub-pixels, each of which has a red color, a green color, or a blue color. In addition, each pixel includes a gate line (not shown) extended in a first direction substantially parallel to one side of the array substrate 110, a data line (not shown) extended in a second direction substantially perpendicular to the first direction and insulated from the gate line while crossing the gate line, and a pixel electrode (not shown). Further, each pixel includes a thin film transistor (not shown) electrically connected to the gate line, the data line, and the pixel electrode. The thin film transistor switches a driving signal applied to the pixel electrode.

In addition, a driver integrated circuit (driver IC) (not shown) may be disposed adjacent to a side of the array substrate 110. The driver IC receives various signals from an external device (not shown) and outputs the driving signal to the thin film transistor in response to the signals to drive the display panel 100.

The opposite substrate 120 may include R, G, and B color filters (not shown) used to produce colors using light provided from the backlight unit (not shown) and a common electrode (not shown) disposed on the R, G, and B color filters to face the pixel electrode. The R, G, and B color filters may be formed by a thin film process. Meanwhile, the color filters are described as being disposed on the opposite substrate 120 in the present exemplary embodiment. In another exemplary embodiment, the color filters may be disposed on the array substrate 110.

The liquid crystal layer 130 includes liquid crystal molecules arranged in a specific direction in response to voltages respectively applied to the pixel electrode and the common electrode, and thereby adjusting a light transmittance of the liquid crystal layer 130 with respect to the light from the backlight unit. As a result, the display panel 100 may display desired images.

A polarization film 140 may be disposed between the display panel 100 and the backlight unit to polarize the light provided from the backlight unit.

The polarization system 200 is disposed adjacent to a surface of the display panel 100, on which the image is displayed, to allow the user to perceive the 3D image.

To this end, the polarization system 200 includes a first polarization film 210 disposed between the user and the display panel 100, a second polarization film 220 disposed between the first polarization film 210 and the display panel 100, and a first retardation film 230 disposed between the first polarization film 210 and the second polarization film 220.

The first polarization film 210 and the second polarization film 220 transmit the incident light thereto after linearly polarizing the incident light. In the present exemplary embodiment, the first polarization film 210 may be a polarization film applied to polarization glasses worn by a user, and the second polarization film 220 may be a polarization film attached on the surface, on which the image is displayed, of the display panel 100.

The first retardation film 230 may be a λ/4 retardation film to allow the light passing therethrough to have ±λ/4 phase retardation. Accordingly, the first retardation film 230 retards the linearly polarized light by ±λ/4 to provide a circularly polarized light.

Hereinafter, the process that the user perceives the 3D image displayed through the 3D image display apparatus shown in FIGS. 1 to 3 will be described in detail.

The display panel 100 receives the light from the backlight unit to display the left-eye image and the right-eye image separately. The left-eye image and the right-eye image are displayed by the light passing through the display panel 100 of the light provided from the backlight unit.

The light passing through the display panel 100 is transmitted to the second polarization film 220. The second polarization film 220 transmits only the light traveling in a direction substantially parallel to a transmission axis thereof, and thus the linearly polarized light exits from the second polarization film 200.

The linearly polarized light transmitted by the second polarization film 220 is transmitted to the first retardation film 230. The first retardation film 230 retards the linearly polarized light by ±λ/4, so that the circularly polarized light exits from the first retardation film 230.

The circularly polarized light transmitted by the first retardation film 230 is transmitted to the first polarization film 210. The first polarization film 210 transmits only the light traveling in a direction substantially parallel to a transmission axis thereof among is the circularly polarized light. Accordingly, the linearly polarized light exits from the first polarization film 210.

According to the 3D image display apparatus shown in FIGS. 1 to 3, the linearly polarized light produced by passing through the second polarization film 220 is converted to the circularly polarized light produced by passing through the first retardation film 230, and the circularly polarized light is converted to the linearly polarized light again by passing through the first polarization film 210. Thus, the viewer may perceive the image without the viewer's posture being related to the angle between the transmission axis of the first polarization film 210 and the transmission axis of the second polarization film 220.

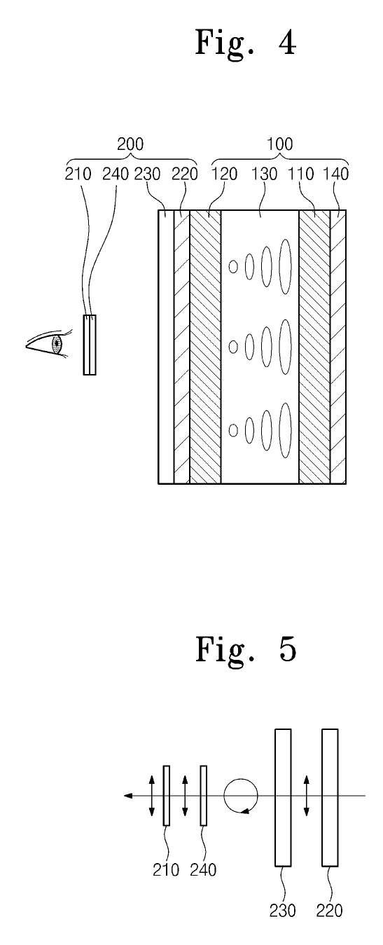

FIG. 4 is a cross-sectional view showing a 3D image display apparatus according to another exemplary embodiment of the present invention, and FIG. 5 is a schematic view explaining a polarization system employed in the 3D image display apparatus shown in FIG. 4. In FIGS. 4 and 5, the same reference numerals denote the same elements in FIGS. 1 to 3, and thus detailed descriptions of the same elements will be omitted.

Referring to FIGS. 4 and 5, a 3D image display apparatus according to another exemplary embodiment further includes a second retardation film 240 disposed between the first polarization film 210 and the first retardation film 230.

The second retardation film 240 may be the λ/4 retardation film as in the first retardation film 230. In addition, the second retardation film 240 may be attached to a surface of the first polarization film 210, which faces the first retardation film 230.

Hereinafter, the process in which the user perceives the 3D image displayed through the 3D image display apparatus shown in FIGS. 4 to 5 will be described in detail.

The light is transmitted through the second polarization film 220. The second polarization film 220 linearly polarizes the light exiting from the display panel 100 and the first retardation film 230 retards the linearly polarized light by ±λ/4. Thus, the circularly polarized light exits from the first retardation film 230.

The circularly polarized light transmitted by the first retardation film 230 is transmitted to the second retardation film 240. The circularly polarized light is converted to the linearly polarized light again by the second retardation film 240. This linearly polarized light travels in a direction substantially parallel to a transmission axis of the first polarization film 210.

Since the linearly polarized light is substantially parallel to the transmission axis of the first polarization film 210, the linearly polarized light is transmitted through the first polarization film 210.

That is, according to the 3D image display apparatus shown in FIGS. 4 to 5, the linearly polarized light, by passing through the second polarization film 220, is converted to the circularly polarized light by passing through the first retardation film 230, and the circularly polarized light is converted to the linearly polarized light again by the second retardation film 240. In addition, the linearly polarized light transmitted by the second retardation film 240 travels in the direction substantially parallel to the transmission axis of the first polarization film 210. Thus, the viewer may perceive the image without the viewer's posture being related to the angle between the transmission axis of the first polarization film 210 and the transmission axis of the second polarization film 220.

In addition, since the light passing through the second polarization film 220 may be transmitted through the first polarization film 210 without significant light loss, the user may perceive the image having improved brightness.

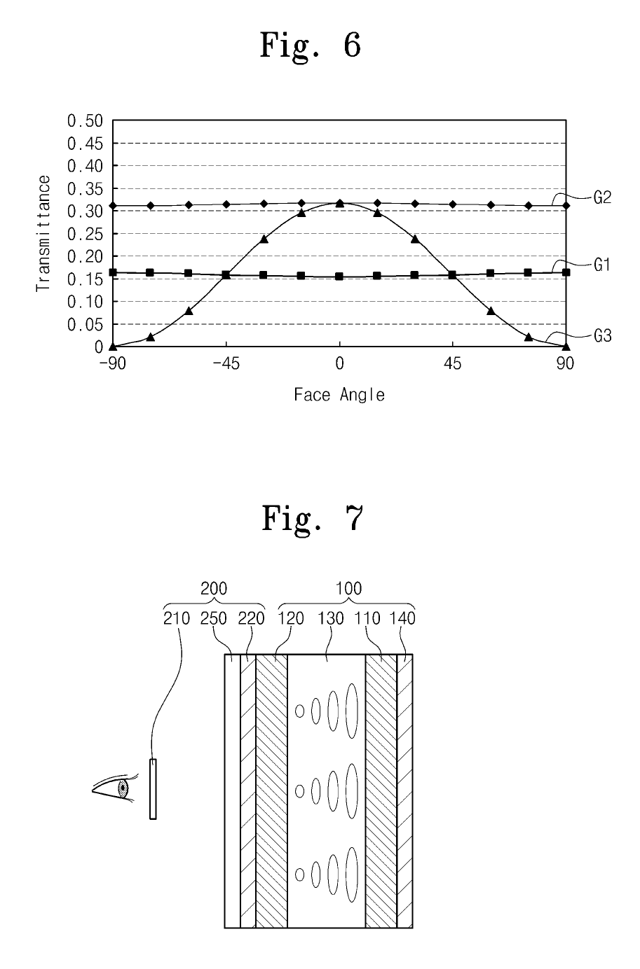

FIG. 6 is a graph showing a transmittance of a polarization system according to a face angle of a user. A first graph G1 indicates the transmittance according to the face angle of the polarization system (first exemplary embodiment) including a polarization film 210, a first retardation film 230, and a second polarization film 220. A second graph G2 indicates the transmittance according to the face angle of the polarization system (second exemplary embodiment) including the first polarization film 210, the first retardation film 230, the second retardation film 240, and the second polarization film 220. A third graph G3 indicates the transmittance according to the face angle of the polarization system (comparison example) including the first polarization film 210 and the second polarization film 220 but no retardation film.

Referring to FIG. 6, the transmittance of the polarization system according to the comparison example is varied depending on the face angle of the viewer, as represented by the third graph G3. This is because the angle between the transmission axis of the first polarization film 210 applied to the polarization glasses worn by the viewer and the transmission axis of the second polarization film 220 attached to the display panel 100 is varied.

In detail, the transmission axis of the first polarization film 210 becomes parallel to the transmission axis of the second polarization film 220 when the user sits or stands to watch the image, and thus the viewer may watch the 3D image having high brightness. However, when the viewer lies down to watch the 3D image, the angle between the transmission axis of the first polarization film 210 and the transmission axis of the second polarization film 220 becomes 90 degrees. As a result, the first polarization film 210 reflects most of the light exiting from the second polarization film 220. Consequently, the viewer may not be able to watch the 3D image displayed by the 3D image display apparatus.

Meanwhile, the transmittance of the polarization system according to the first exemplary embodiment is essentially uniform regardless of the face angle of the viewer, as represented by the first graph G1. Thus, the viewer may watch the 3D image having uniform brightness. This is because the light exiting from the second polarization film 220 is circularly polarized by the first retardation film 230 and the first polarization film 210 transmits only the light traveling in the direction substantially parallel to the transmission axis thereof.

As in the polarization system according to the first exemplary embodiment, the transmittance of the polarization system according to the second exemplary embodiment is essentially uniform regardless of the face angle, so the viewer may watch the 3D image having the uniform brightness.

Further, the polarization system according to the second exemplary embodiment has a superior light transmittance when compared with the polarization system according to the first exemplary embodiment. This is because the circularly polarized light by the first retardation film 230 is converted to the linearly polarized light traveling in the direction substantially parallel to the transmission axis of the first polarization film 210 by the second retardation film 240. That is, the polarization system according to the first exemplary embodiment provides only the light traveling in the direction substantially parallel to the transmission axis of the first polarization film 210 among the circularly polarized light transmitted by the first retardation film 230, but the polarization system according to the second exemplary embodiment converts the circularly polarized light transmitted by the first retardation film 230 to the light traveling in the direction substantially parallel to the transmission axis of the first polarization film 210 before providing the circularly polarized light to the viewer.

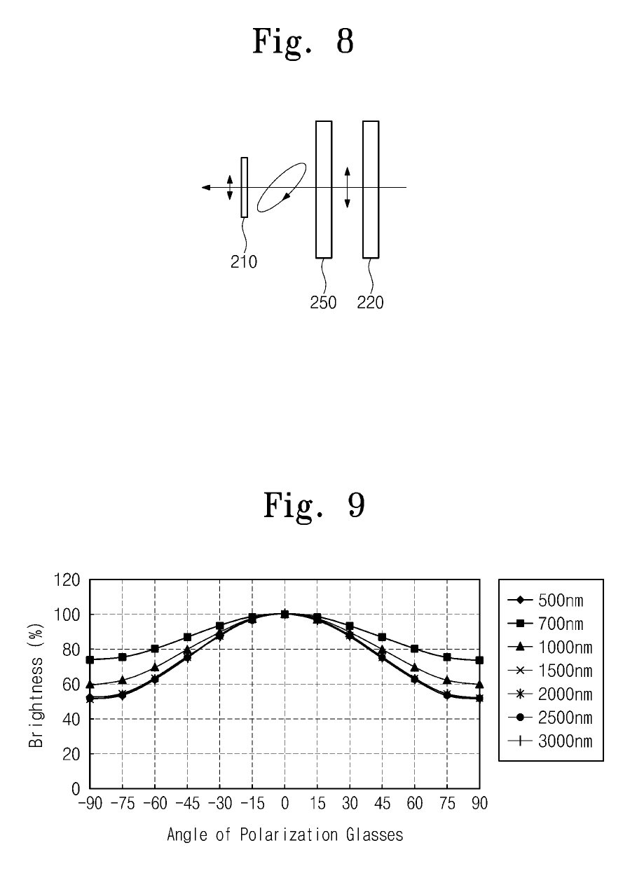

FIG. 7 is a cross-sectional view showing a 3D image display apparatus according to another exemplary embodiment of the present invention, and FIG. 8 is a schematic view explaining a polarization system employed in the 3D image display apparatus shown in FIG. 7. In FIGS. 7 and 8, the same reference numerals denote the same elements in FIGS. 1 to 3, except as described below, and thus detailed descriptions of the same elements will be omitted.

Referring to FIGS. 7 and 8, the 3D image display apparatus further includes a third retardation film 250 disposed between the first polarization film 210 and the second polarization film 220, where the third retardation film 250 is substituted for the first retardation film 230 shown in FIGS. 1-3. The first retardation film 250 has a thickness equal to or smaller than 1500 nm.

In the present exemplary embodiment, the third retardation film 250 may include polyethylene terephthalate (PET). The polyethylene terephthalate has birefringence and may be produced by a drawing process.

When the third retardation film 250 is uniaxially oriented after being molded, the retardation variation of the first retardation film 250 may be more than λ/4. The retardation variation of the third retardation film 250 is represented by the following Equation.

Δ=(nₓ−n_{y})×d Equation

In the Equation, when a direction substantially parallel to a surface of the third retardation film 250 is referred to as an x-axis and a direction substantially perpendicular to the surface of the third retardation film 250 (e.g., the x-axis) is referred to as a y-axis, “nₓ” denotes a refractive index in an x-axis direction, “n_{y}” denotes a refractive index in a y-axis direction, and “d” denotes a thickness of the third retardation film 250.

The process in which the viewer perceives the 3D image displayed through the 3D image display apparatus shown in FIGS. 7 to 8 is as follows.

The second polarization film 220 linearly polarizes the light exiting from the display panel 100.

The linearly polarized light is transmitted through the third retardation film 250. The third retardation film 250 retards the linearly polarized light to convert the linearly polarized light to an elliptically polarized light.

The elliptically polarized light exiting from the third retardation film 250 is transmitted to the first polarization film 210. The first polarization film 210 transmits only the light traveling in the direction substantially parallel to the transmission axis thereof among the elliptically polarized light to provide the linearly polarized light.

That is, according to the 3D image display apparatus shown in FIGS. 7 and 8, the light exiting from the second polarization film 220 is elliptically polarized by the third retardation film 250 and the first polarization film 210 transmits only the light traveling in the direction substantially parallel to the transmission axis thereof among the elliptically polarized light to provide the linearly polarized light. Thus, the viewer may perceive the image without his posture being related to the angle between the transmission axis of the first polarization film 210 and the transmission axis of the second polarization film 220.

FIG. 9 is a graph showing a brightness variation according to a thickness of a third retardation film and an angle of polarization glasses of the 3D image display apparatus shown in FIGS. 7 and 8. In this case, the brightness variation is measured after applying polyethylene terephthalate as the third retardation film.

Referring to FIG. 9, although the viewer sits or stands to watch the 3D image, no brightness variation occurs in the polarization system 200 employing the third retardation film 250. In addition, the viewer may watch the 3D image having the brightness equal to or higher than 50% of the maximum brightness even if the viewer lies down to watch the 3D image.

Meanwhile, as the thickness of the third retardation film 250 is reduced, the reduction of the brightness according to the posture of the viewer becomes small. Particularly, in the case that the thickness of the third retardation film 250 is below about 1500 nm, the reduction of the brightness becomes small.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A polarization system comprising:
a first polarization film configured to be disposed between a viewer and a light irradiator;
a second polarization film configured to be disposed between the first polarization film and the light irradiator; and
a first retardation film configured to be disposed between the first polarization film and the second polarization film and configured to retard a phase of light exiting from the first polarization film.

2. The polarization system of claim 1, wherein the first polarization film and the second polarization film are configured to linearly polarize light incident thereto.

3. The polarization system of claim 2, wherein a retardation variation produced by the first retardation film is about λ/4 and the first retardation film circularly polarizes the light passing therethrough.

4. The polarization system of claim 3, further comprising a second retardation film configured to be disposed between the first retardation film and the first polarization film.

5. The polarization system of claim 4, wherein a retardation variation produced by the second retardation film is about λ/4 and the second retardation film linearly polarizes the light passing therethrough to be substantially parallel to a transmission axis of the first polarization film.

6. The polarization system of claim 1, wherein a retardation variation produced by the first retardation film is more than λ/4.

7. The polarization system of claim 6, wherein the retardation variation (Δ) produced by the first retardation film is represented by the following Equation,
Δ=(nₓ−n_{y})×d
where, when a direction substantially parallel to a surface of the first retardation film is referred to as an x-axis and a direction substantially perpendicular to the surface of the first retardation film is referred to as a y-axis, “nₓ” denotes a refractive index in an x-axis direction, “n_{y}” denotes a refractive index in a y-axis direction, and “d” denotes a thickness of the first retardation film.

8. The polarization system of claim 6, wherein the first retardation film comprises polyethylene terephthalate.

9. The polarization system of claim 8, wherein the first retardation film has a thickness equal to or smaller than 1500 nm.

10. A 3D image display apparatus comprising:
a display panel configured to display a left-eye image and a right-eye image separately; and
a polarization system configured to be disposed adjacent to a surface of the display panel, on which the left and right images are displayed, to allow a viewer to perceive a 3D image, the polarization system comprising:
a first polarization film configured to be disposed between the viewer and the display panel;
a second polarization film configured to be disposed between the first polarization film and the display panel; and
a first retardation film configured to be disposed between the first polarization film and the second polarization film to retard a light exiting from the first polarization film.

11. The 3D image display apparatus of claim 10, wherein the first polarization film and the second polarization film are configured to linearly polarize the light incident thereto.

12. The 3D image display apparatus of claim 11, wherein a retardation variation produced by the first retardation film is about λ/4 and the first retardation film is configured to circularly polarize the light passing therethrough.

13. The 3D image display apparatus of claim 12, further comprising a second retardation film configured to be disposed between the first retardation film and the second polarization film.

14. The 3D image display apparatus of claim 13, wherein a retardation variation produced by the second retardation film is about λ/4 and the second retardation film linearly is configured to polarize the light passing therethrough to be substantially parallel to a transmission axis of the first polarization film.

15. The 3D image display apparatus of claim 10, wherein a retardation variation produced by the first retardation film is more than λ/4.

16. The 3D image display apparatus of claim 15, wherein the retardation variation (Δ) produced by the first retardation film is represented by the following Equation,
Δ=(nₓ−n_{y})×d
where, when a direction substantially parallel to a surface of the first retardation film is referred to as an x-axis and a direction substantially perpendicular to the surface of the first retardation film is referred to a y-axis, “nₓ” denotes a refractive index in an x-axis direction, “n_{y}” denotes a refractive index in a y-axis direction, and “d” denotes a thickness of the first retardation film.

17. The 3D image display apparatus of claim 15, wherein the first retardation film comprises polyethylene terephthalate.

18. The 3D image display apparatus of claim 17, wherein the first retardation film has a thickness equal to or smaller than 1500 nm.

19. The polarization system of claim 6, wherein the first retardation film is configured to elliptically polarize the light passing therethrough.

20. The 3D image display apparatus of claim 15, wherein the first retardation film is configured to elliptically polarize the light passing therethrough.

21. The polarization system of claim 1, wherein the first retardation film is disposed directly on the second polarization film, and the first polarization film is configured to be spaced apart from the first retardation film.
